(19) United States
(12) Patent Application Publication
(10) Pub. No.: US 2022/0358608 A1
(43) Pub. Date: Nov. 10, 2022

(54) SYSTEM AND METHOD FOR PROCESSING DISCOVERY DOCUMENTS IN A LEGAL INDUSTRY

(71) Applicant: Jeff Schwartz, Santa Monica, CA (US)

(72) Inventor: Jeff Schwartz, Santa Monica, CA (US)

(21) Appl. No.: 17/735,180

(22) Filed: May 3, 2022

Related U.S. Application Data
(63) Continuation-in-part of application No. 17/314,076, filed on May 7, 2021, now abandoned.

(51) Int. Cl. G06Q 50/18

(52) U.S. Cl. CPC G06Q 50/18

(57) ABSTRACT

A system and method for processing discovery documents in a legal industry is disclosed. The method includes receiving a request from one or more propounding users to generate a discovery request and determining the one or more discovery devices. The method further includes performing one or more operations corresponding to the determined one or more discovery devices for generating one or more discovery documents and determining one or more responses corresponding to a set of interrogatories or requests. Further, the method includes generating one or more additional response documents by using a document management-based AI model and outputting the determined one or more responses and the generated one or more additional response documents on user interface screen of one or more propounding devices associated with the one or more propounding users.

### CROSS-REFERENCE TO RELATED APPLICATIONS

This application is a continuation in part of a non-provisional patent application filed in the US having patent application Ser. No. 17/314,076 filed on May 7, 2021 and titled “A SYSTEM AND A METHOD FOR DOCUMENT MANAGEMENT OF A DISCOVERY PROCESS”.

### FIELD OF INVENTION

Embodiments of the present disclosure relate to AI (Artificial Intelligence)-based processing system and more particularly relates to a system and a method for processing discovery documents in a legal industry.

### BACKGROUND

Generally, civil lawsuits in every state, as well as the federal system, include a “discovery” process where each side gets to ask questions of its opposing side, in the form of interrogatories and requests. Conventionally, discovery questions and their responses have been written on paper and served via U.S. Mail or overnight carriers. The act of sending discovery to the opposing side for a response is called “propounding”. The act of sending discovery responses to propounding side is called “responding.” The act of sending discovery questions or responses is called “serving”. Further, some states, including California, have rules in place to permit use of written discovery forms, such as Form Interrogatories—General (FROGS) and Form Interrogatories—Employment (FROGSE). FROGS is a form including 8 pages of pre-created questions. The user, such as an attorney or a paralegal, checks a box for each question they want to propound. Furthermore, the FROGSE includes the same format as the FROGS form, but the questions are geared toward employment litigation. All jurisdictions permit the use of (generally non-form) written discovery devices including Special Interrogatories (SROGS), Requests for Admissions (RFAS) and Requests for Production of Documents (RPDS). SROGS is a form in which a user drafts questions they want to ask the opposing side. RFAS is a form in which a user requests the opposing side to “admit” or “deny” statements created by the one or more propounding users. Further, RPDS is a form in which user drafts requests for documents or the inspection of things.

Further, the responding law firm sends the discovery to their client. The client then writes their responses on a separate piece of paper or in a Word® .docx document which they send back to the responding law firm. Since FROGS and FROGSE include 8 pages of dense questions, it is required that the user notes which questions are selected for propounding responses from the client. The questions often also include one or more subparts. However, there exists a problem that clients may fail to notice and respond to some subparts of the questions. Also, there is a likelihood that clients may respond to the questions in paragraphs in a very subjective manner. In such cases, the responding user is required to segregate the parts of the paragraph and put each of relevant parts into the response corresponding to appropriate question. Further, clients are often laymen to the arcane details and nuances in the field of law, therefore client responses are often not code compliant, i.e., in the form required by the jurisdiction's rules.

Hence, there is a need for an improved system and method for processing discovery documents in a legal industry, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a computing system for processing discovery documents in a legal industry is disclosed. The computing system includes one or more hardware processors and a memory coupled to the one or more hardware processors. The memory includes a plurality of modules in the form of programmable instructions executable by the one or more hardware processors. The plurality of modules include a request receiver module configured to receive a request from one or more propounding users to generate a discovery request via one or more propounding devices. The request includes at least one of: case number, case name, plaintiffs and defendants, letterhead, parties, jurisdiction of case, user data, and service list. The discovery request corresponds to one of: a set of interrogatories and requests in one or more discovery devices. The plurality of modules also include a device determination module configured to determine the one or more discovery devices corresponding to the received request based on predefined device information, type of user, and the received request by using a document management-based Artificial Intelligence (AI) model. Each of the one or more discovery devices comprises one of: the set of interrogatories and requests. The plurality of modules includes an operation performing module configured to perform one or more operations corresponding to the determined one or more discovery devices based on the predefined device information and the determined one or more discovery devices by using the document management-based AI model for generating one or more discovery documents. The one or more discovery documents include at least one of: one or more form devices, one or more non-form devices, one or more ancillary documents, one or more additional documents, and a Proof of Service (POS). The one or more discovery devices and the one or more discovery documents are outputted to one or more responding devices associated with one or more responding users. Further, the plurality of modules includes a response determination module configured to determine one or more responses corresponding to one of: the set of interrogatories and requests associated with the one or more discovery devices based on a set of rules for a jurisdiction where litigation is taking place, the predefined device information, the determined one or more discovery devices, the generated one or more discovery documents and the received request by using the document management-based AI model upon performing the one or more operations. The plurality of modules also include a document generation module configured to generate one or more additional response documents based on the set of rules, the predefined device information, the determined one or more discovery devices, the generated one or more discovery documents and the received request by using the document management-based AI model. Furthermore, the plurality of modules include a data output module configured to output the determined one or more responses and the generated one or more additional response documents on user interface screen of the one or more responding devices associated with the one or more responding users.

In accordance with another embodiment of the present disclosure, a method for processing discovery documents in a legal industry is disclosed. The method includes receiving a request from one or more propounding users to generate a discovery request via one or more propounding devices. The request includes at least one of: case number, case name, plaintiffs and defendants, letterhead, parties, jurisdiction of case, user data, and service list. The discovery request corresponds to one of: a set of interrogatories and requests in one or more discovery devices. The method also includes determining the one or more discovery devices corresponding to the received request based on predefined device information, type of user, and the received request by using a document management-based AI model. Each of the one or more discovery devices comprises one of: the set of interrogatories and requests. The method further includes performing one or more operations corresponding to the determined one or more discovery devices based on the predefined device information and the determined one or more discovery devices by using the document management-based AI model for generating one or more discovery documents. The one or more discovery documents include at least one of: one or more form devices, one or more non-form devices, one or more ancillary documents, one or more additional documents, and POS. The one or more discovery devices and the one or more discovery documents are outputted to one or more responding devices associated with one or more responding users. Further, the method includes determining one or more responses corresponding to one of: the set of interrogatories and requests associated with the one or more discovery devices based on a set of rules for a jurisdiction where litigation is taking place, the predefined device information, the determined one or more discovery devices, the generated one or more discovery documents and the received request by using the document management-based AI model upon performing the one or more operations. Also, the method includes generating one or more additional response documents based on the set of rules, the predefined device information, the determined one or more discovery devices, the generated one or more discovery documents and the received request by using the document management-based AI model. Furthermore, the method includes outputting the determined one or more responses and the generated one or more additional response documents on user interface screen of the one or more responding devices associated with the one or more responding users.

Embodiment of the present disclosure also provide a non-transitory computer-readable storage medium having instructions stored therein that, when executed by a hardware processor, cause the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating an exemplary computing environment for processing discovery documents in a legal industry, in accordance with an embodiment of the present disclosure;

FIG. 2 is a block diagram illustrating an exemplary computing system for processing discovery documents in the legal industry, in accordance with an embodiment of the present disclosure;

FIG. 3 is a process flow diagram illustrating an exemplary method for processing discovery documents in the legal industry, in accordance with an embodiment of the present disclosure;

FIG. 4A is an exemplary portion of a form interrogatory for receiving one or more responses, in accordance with an embodiment of the present disclosure;

FIG. 4B is an exemplary portion of the form interrogatory for receiving the one or more responses, in accordance with another embodiment of the present disclosure;

FIG. 4C is an exemplary form interrogatory depicting formatting and set of content issues, in accordance with an embodiment of the present disclosure; and

FIG. 4D is an exemplary form interrogatory depicting sample demand for supplementation of the responses, in accordance with another embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

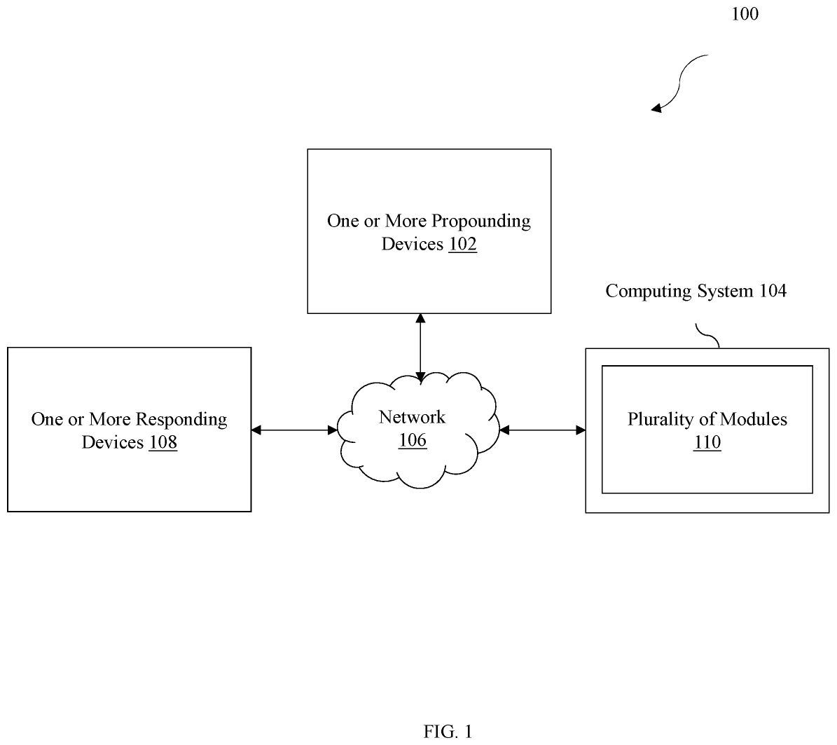

Referring now to the drawings, and more particularly to FIG. 1 through FIG. 4D, where similar reference characters denote corresponding features consistently throughout the figures, there are shown preferred embodiments and these embodiments are described in the context of the following exemplary system and/or method.

FIG. 1 is a block diagram illustrating an exemplary computing environment 100 for processing discovery documents in a legal industry, in accordance with an embodiment of the present disclosure. According to FIG. 1, the computing environment 100 includes one or more propounding devices 102 associated with one or more propounding users communicatively coupled to a computing system 104 via a network 106. In an embodiment of the present disclosure, the one or more propounding users may include propounding firm, their clients or a combination thereof which send a discovery document to the opposing side for a response. The discovery is a process in a civil lawsuit where each side gets to ask questions from the opposing side. Further, the one or more propounding devices 102 are used by the one or more propounding users for requesting the computing system 104 to generate a discovery request. In an embodiment of the present disclosure, the discovery request corresponds to a set of interrogatories or requests in one or more discovery devices. Furthermore, the one or more propounding devices 102 are also used by the one or more propounding users to receive one or more responses and one or more additional response documents. The computing system 104 may be hosted on a central server, such as cloud server or a remote server. Further, the network 106 may be a Wireless-Fidelity (Wi-Fi) connection, a hotspot connection, a Bluetooth connection, a local area network, a wide area network or any other wireless network.

Further, the computing environment 100 includes one or more responding devices 108 associated with one or more responding users communicatively coupled to the computing system 104 via the network 106. In an embodiment of the present disclosure, the one or more responding users may include responding firm, their clients or a combination thereof which provides one or more responses for the discovery shared by the one or more responding users. The one or more responding devices 108 are used by the one or more responding users to receive one or more discovery documents. Furthermore, the one or more responding devices 108 are also used by the one or more responding users to provide one or more discovery responses for the one or more discovery devices. In an exemplary embodiment of the present disclosure, the one or more responding devices 102 and the one or more responding devices 108 may include a laptop computer, desktop computer, tablet computer, smartphone, wearable device, smart watch and the like.

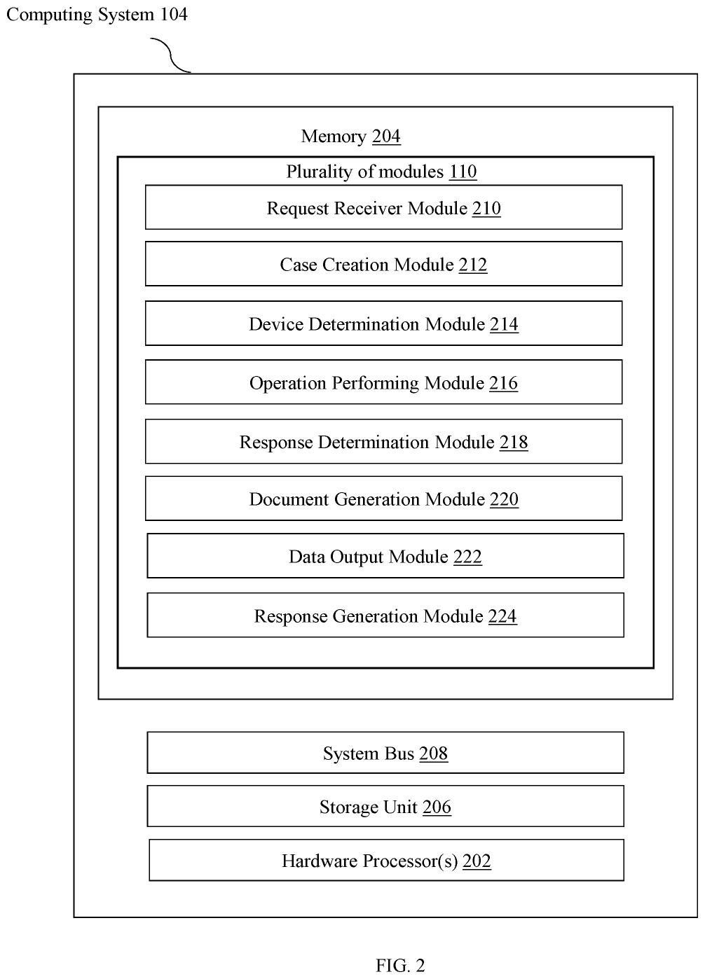

Furthermore, the one or more responding devices 102 and the one or more responding devices 108 include a local browser, a mobile application or a combination thereof. Furthermore, the one or more responding users and the one or more responding users may use a web application via the local browser, the mobile application or a combination thereof to communicate with the computing system 104. In an embodiment of the present disclosure, the computing system 104 includes a plurality of modules 110. Details on the plurality of modules 110 have been elaborated in subsequent paragraphs of the present description with reference to FIG. 2.

In an embodiment of the present disclosure, the computing system 104 is configured to receive the request from the one or more propounding users to generate the discovery request via the one or more propounding devices 102. Further, the computing system 104 determines the one or more discovery devices corresponding to the received request based on predefined device information, type of user, and the received request by using a document management-based Artificial Intelligence (AI) model. The computing system 104 performs one or more operations corresponding to the determined one or more discovery devices based on the predefined device information and the determined one or more discovery devices by using the document management-based AI model for generating the one or more discovery documents. The computing system 104 determines the one or more responses corresponding to the set of interrogatories or requests associated with the one or more discovery devices based on a set of rules for a jurisdiction where litigation is taking place, the predefined device information, the determined one or more discovery devices, the generated one or more discovery documents and the received request by using the document management-based AI model upon performing the one or more operations. The computing system 104 generates one or more additional response documents based on the set of rules, the predefined device information, the determined one or more discovery devices, the generated one or more discovery documents and the received request by using the document management-based AI model. Further, the computing system 104 outputs the determined one or more responses and the generated one or more additional response documents on user interface screen of the one or more responding devices 102 associated with the one or more responding users.

FIG. 2 is a block diagram illustrating an exemplary computing system 104 for processing discovery documents in the legal industry, in accordance with an embodiment of the present disclosure. Further, the computing system 104 includes one or more hardware processors 202, a memory 204 and a storage unit 206. The one or more hardware processors 202, the memory 204 and the storage unit 206 are communicatively coupled through a system bus 208 or any similar mechanism. The memory 204 comprises the plurality of modules 110 in the form of programmable instructions executable by the one or more hardware processors 202. Further, the plurality of modules 110 includes a request receiver module 210, a case creation module 212, a device determination module 214, an operation performing module 216, a response determination module 218, a document generation module 220, a data output module 222 and a response generation module 224.

The one or more hardware processors 202, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 202 may also include embedded controllers, such as generic or programmable logic devices or arrays, application specific integrated circuits, single-chip computers, and the like.

The memory 204 may be non-transitory volatile memory and non-volatile memory. The memory 204 may be coupled for communication with the one or more hardware processors 202, such as being a computer-readable storage medium. The one or more hardware processors 202 may execute machine-readable instructions and/or source code stored in the memory 204. A variety of machine-readable instructions may be stored in and accessed from the memory 204. The memory 204 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 204 includes the plurality of modules 110 stored in the form of machine-readable instructions on any of the above-mentioned storage media and may be in communication with and executed by the one or more hardware processors 202.

The storage unit 206 may be a cloud storage, a Structured Query Language (SQL) data store or a location on a file system directly accessible by the plurality of modules 110. The storage unit 206 may store the received request, the predefined device information, type of user, the one or more discovery documents and the one or more responses. The storage unit 206 may also store the set of rules, the one or more additional response documents, a set of form inputs, one or more interrogatories or requests inputs, one or more definitions, one or more ancillary documents, one or more signature requirements, one or more formats, a status response, one or more bases, one or more discovery responses, a meet and confer document, a set of responses, one or more predefined ranking rules and the like.

The request receiver module 210 is configured to receive the request from the one or more propounding users to generate the discovery request via the one or more propounding devices 102. In an embodiment of the present disclosure, the one or more propounding users may include the propounding firm, their clients or a combination thereof which send a discovery to the opposing side for a response. The discovery is a process in a civil lawsuit where each side gets to ask questions from opposing side. In an exemplary embodiment of the present disclosure, the one or more propounding devices 102 may include a laptop computer, desktop computer, tablet computer, smartphone, wearable device, smart watch, and the like. In an exemplary embodiment of the present disclosure, the request includes case number, case name, plaintiffs and defendants, letterhead, parties, jurisdiction of case, user data, service list, or a combination thereof. In an embodiment of the present disclosure, the discovery request corresponds to the set of interrogatories or requests in the one or more discovery devices. In an exemplary embodiment of the present disclosure, the user data may include user id, password, name, contact details and the like of the one or more propounding users. In an embodiment of the present disclosure, the one or more propounding users may select a case or lawsuit from their case list for generating the discovery request for the case. The case list is list of all cases in which the one or more propounding users are members of the case's team.

In an embodiment of the present disclosure, before selecting the case from the case list, the case must be created. The case creation module 212 is configured to receive the user data from one or more users. In an embodiment of the present disclosure, the one or more users may be the one or more propounding users. Further, the case creation module 212 determines if the one or more users are allowed to create a case based on the received user data and the predefined discovery information by using the document management-based AI model. In an embodiment of the present disclosure, an attorney, a support person in the attorney's team or a combination thereof is allowed to create a case. The attorney has a team of professionals, such as other attorneys or support staff, who commonly work on cases with him. Further, the case creation module 212 outputs a form for receiving case information from the one or more users upon determining that the one or more users are allowed to create a case. In an exemplary embodiment of the present disclosure, the form includes a set of fields, such as case number, case name, plaintiffs and defendants, trial and discovery cutoff dates, lead counsel, letterhead, parties, case team, service list and the like. For example, the lead counsel is the primary attorney handling the case. The lead counsel may be a user creating the case. In an embodiment of the present disclosure, all questions i.e., requests or interrogatories and responses issued in the case use the case's Letterhead, regardless of who created it. This facilitates the use of pool paralegals and contract attorneys, both of which perform work for multiple attorneys. In an embodiment of the present disclosure, all members of the case's team have equal access to the case information for the party they represent. When the case is created, it inherits the lead counsel's team as the case's team. However, case team members may add or delete people from the case's team. Further, the service list discloses name of one or more individuals to whom all documents associated with the case are to be served. In an embodiment of the present disclosure, when the one or more users enter the case number in the form, the case creation module 212 determines if the case has already been created. When the case has already been created, the one or more users are provided with an option to either request to join the existing case representing a party or continue creating a new case. In an embodiment of the present disclosure, cases numbers may include text. In an embodiment of the present disclosure, digits of the cases are matched to determine if the case has already been created. In an embodiment of the present disclosure, if the one or more users request to join the existing case, the one or more users designate the party they represent. Further, one or more emails are shared with everyone on that party's case team, allowing any of them to grant the request. In an embodiment of the present disclosure, when the one or more users enter the trial date in the form, the case creation module 212 determines the discovery cutoff date based on the trial date and the predefined device information by using the document management-based AI model. For example, in California state cases, the discovery cutoff date is 30 days before the Trial date, adjusting for weekends and court holidays. The case creation module 212 determines if the one or more users are the attorney or if the one or more users are a member of any attorney's team. Further, the case creation module 212 provides a dropdown list including the user, if they're an attorney or a member of any attorney's team. The one or more users select the case's lead counsel from the dropdown list. When the case is saved, the case creation module 212 creates the case's letterhead from the lead counsel's letterhead. In an embodiment of the present disclosure, future changes to the case's letterhead do not affect the lead counsel's letterhead. Furthermore, the one or more users add the parties to the case including their name, role, and their representation. For example, the role may be .e., plaintiff, defendant, and the like. For example, the representation may be the user's law firm, another attorney, or Pro Per. If the user represents the party, the Party's email address is required to collaborate with the party. In an embodiment of the present disclosure, the service list includes name, email, and party affiliation of the one or more individuals to whom the documents are required to be served.

The device determination module 214 is configured to determine the one or more discovery devices corresponding to the received request based on the predefined device information, type of user, and the received request by using the document management-based AI model. In an embodiment of the present disclosure, the document management-based AI model may be a Machine Learning (ML) model. In an embodiment of the present disclosure, each of the one or more discovery devices includes the set of interrogatories. In an embodiment of the present disclosure, the type of user may be determined based on the user data. For example, the type of users is of two types i.e., service providers such as attorneys, paralegals, and secretaries, and responding party or clients. Therefore, in an exemplary embodiment, the type of user includes an attorney and a support staff Thereby, an attorney access and a support staff access are determined for the attorney and the support staff, respectively, based on the received user data. In an embodiment of the present disclosure, the clients are sent a link that allows them to respond to discovery. In an embodiment of the present disclosure, the differences between attorneys and non-attorneys i.e., the support staff are that only an attorney or a non-attorney who is a member of an attorney's team can create a case. Further, only attorneys can be lead counsel. Furthermore, some forms, such as a declaration for additional discovery in California state court must be signed by an attorney. All members of a case's team have equal rights to create, edit, delete, and serve discovery requests and responses. In an exemplary embodiment of the present disclosure, the one or more discovery devices for California include Form Interrogatories—General (FROGS), Form Interrogatories—Employment (FROGSE), Requests for Admission (RFAS), Special Interrogatories (SROGS), Requests for Production of Documents (RPDS) and the like. The RPDS may also be known as request for inspection of things. In an embodiment of the present disclosure, the FROGS allows the one or more propounding users to select pre-created questions. In an embodiment of the present disclosure, the FROGSE is similar to the FROGS, but the questions relate to employment issues. In RFAS, the one or more propounding users create requests to ask the one or more responding users or the responding client to admit to. Further, in SROGS, the one or more propounding users create questions to ask the one or more responding users. In RPDS, the one or more propounding users may ask for specific documents or to inspect items or real property. Further, the set of interrogatories are a set of questions which the one or more propounding users administer on the one or more responding users. The predefined device information includes case information, user information, discovery information, court holidays for every supported jurisdiction, jurisdiction's rules, a set of form devices used in every supported jurisdiction, a library of definitions of words and phrases used in discovery, a library of objections available in every jurisdiction for specific discovery device, one or more objection killers and the like. For example, the set of rules include all rules corresponding to both statutory and common law controlling the discovery in every supported jurisdiction. The jurisdiction is federal, state, and county (state) or district (federal) where a case is being litigated. The case information includes case numbers, case names, plaintiffs and defendants, trial and discovery cut-off dates, lead counsels, and the like. Further, the user information includes name of client, name of attorney, contact details of client and the like. The discovery information includes documents associated with discovery, interrogatories and the like. In an embodiment of the present disclosure, the set of form devices correspond to discovery forms used in every supported jurisdiction. Furthermore, the one or more objection killers are library of authority in the jurisdiction which invalidate boilerplate objections. In an embodiment of the present disclosure, the one or more responding users or the responding client must respond to the set of interrogatories or requests in writing. For example, the one or more responding users may include responding firm, their clients or a combination thereof which provides one or responses for the discovery shared by the one or more propounding users. In an embodiment of the present disclosure, an interface to offer the one or more propounding users is determined based on the predefined device information. The interface corresponds to one or more screen prompts that direct or allow a user to make choices.

The operation performing module 216 is configured to perform the one or more operations corresponding to the determined one or more discovery devices based on the predefined device information and the determined one or more discovery devices by using the document management-based AI model for generating the one or more discovery documents. In an embodiment of the present disclosure, the one or more discovery devices may be stored in the storage unit 206. In an exemplary embodiment of the present disclosure, the one or more discovery documents include one or more form devices, one or more non-form devices, one or more ancillary documents, one or more additional documents, Proof of Service (POS), and the like. In an embodiment of the present disclosure, the one or more discovery devices and the one or more discovery documents are outputted to the one or more responding devices 108 associated with the one or more responding users. In an exemplary embodiment of the present disclosure, the one or more responding devices 108 may include a laptop computer, desktop computer, tablet computer, smartphone, wearable device, smart watch, and the like. In performing the one or more operations corresponding to the determined one or more discovery devices based on the predefined device information and the determined one or more discovery devices by using the document management-based AI model for generating the one or more discovery documents, the operation performing module 216 receives a set of form inputs corresponding to the determined one or more discovery devices from the one or more propounding users. In an embodiment of the present disclosure, the set of form inputs correspond to selection of the one or more form devices or the one or more non-form devices from the determined one or more discovery devices. In an exemplary embodiment of the present disclosure, the one or more form devices include FROGS and FROGSE. The one or more non-form devices include RFAS, SROGS and RPDS. Furthermore, the operation performing module 216 receives one or more interrogatories inputs from the one or more propounding users to select the set of interrogatories associated with the one or more form devices when the set of form inputs corresponds to the selection of the one or more form devices. For example, the one or more form devices are outputted to the one or more propounding users to select eight interrogatories by providing the one or more interrogatories inputs, such that the one or more responding users or the responding client may respond to the eight interrogatories. The one or more users may also de-select interrogatories. The operation performing module 216 determines if the selected set of interrogatories affect one or more other interrogatories in the one or more form devices based on the received request and the predefined device information by using the document management-based AI model. For example, FROGS Nos. 6.2-6.7 are only selectable if No. 6.1 has been selected. The operation performing module 216 generates a set of text boxes corresponding to the one or more non-form devices for receiving response to the set of interrogatories when the set of form inputs corresponds to the selection of the one or more non-form devices. In an exemplary embodiment of the present disclosure, the set of text boxes are generated for entering questions, requests, interrogatories or a combination thereof by the one or more propounding users. Further, the operation performing module 216 determines one or more definitions that may be inserted in the selected one or more form devices and the selected one or more non-form devices based on the received request and the predefined device information by using the document management-based AI model. In an embodiment of the present disclosure, it is also determined if the one or more definitions are permitted for the selected one or more form devices or the selected one or more non-form devices in a particular jurisdiction. The operation performing module 216 generates the one or more ancillary documents corresponding to the selected one or more form devices or the selected one or more non-form devices based on one or more ancillary parameters, the received request and the predefined device information by using the document management-based AI model. In an embodiment of the present disclosure, it is also determined if the one or more ancillary documents are required based on the predefined device information before generating the one or more ancillary documents. In an exemplary embodiment of the present disclosure, the one or more ancillary parameters include number of interrogatories or requests, number of interrogatories or requests previously propounded and type of discovery devices. For example, if more than 35 RFAS or SROGS have been issued by same propounding one or more users i.e., issuing party to same respondent i.e., responding party in California state court, a Declaration for Additional Discovery (DAD) is required. Further, the DAD is created, such that a user can sign it. The operation performing module 216 determine one or more signature requirements corresponding to the one or more form devices and the one or more non-form devices based on the received request and the predefined device information by using the document management-based AI model. For example, the one or more signature requirements may be that an attorney's or client's signature is required on a form device. In another example, in California state court, the DAD can only be signed by an attorney. If the user isn't an attorney, the AI model instructs to the user to have an attorney on the case's team sign it. Further, the operation performing module 216 determines one or more formats required for the POS for generating the POS based on the received request and the predefined device information by using the document management-based AI model. For example, information, such as the case number, case's letterhead, service list and the like, is obtained from the storage unit 206 to create a completed POS that the user can sign with a mouse click. In an embodiment of the present disclosure, the user is prompted to pay for service for generating the discovery request. Further, the one or more discovery documents in served to the one or more individuals on the service list. The operation performing module 216 determines the one or more additional documents required for the selected one or more form devices and the selected one or more non-form devices based on the received request and the predefined device information by using the document management-based AI model. For example, it is determined if in the current jurisdiction, the selected one or more form devices or the selected one or more non-form devices is commonly propounded in conjunction with another device. In the California state court, RFAS may be propounded in conjunction with FROGS or FROGSE in order to force the respondent to provide bases for their refusals to admit any RFAS. If such an additional device is found, the user is prompted to create it, and links the two devices in the storage unit 206, such that when devices are being responded to, the document management-based AI model is aware of and enforces their connection.

The response determination module 218 is configured to determine the one or more responses corresponding to the set of interrogatories or requests associated with the one or more discovery devices based on the set of rules, the predefined device information, the determined one or more discovery devices, the generated one or more discovery documents and the received request by using the document management-based AI model upon performing the one or more operations. For example, using the document management-based AI model to respond requires that the requests or interrogatories are in the storage unit 206. If the discovery was propounded via the document management-based AI model, that's automatic. If not, the document management-based AI model allows the one or more responding user to easily recreate the requests or interrogatories. In an exemplary embodiment of the present disclosure, the one or more responses include reasons of not having documents responsive to an RPD, one or more questions, one or more answers to the one or more questions and the set of interrogatories, a name and an address of a person or an organization, a specific language required in response to a question or any combination thereof. In determining the one or more responses corresponding to the set of interrogatories or requests associated with the one or more discovery devices based on the set of rules, the predefined device information, the determined one or more discovery devices and the received request by using the document management-based AI model upon performing the one or more operations, the response determination module 218 correlates the set of rules, the predefined device information, the determined one or more discovery devices and the received request by using the document management-based AI model. Further, the response determination module 218 determines the one or more responses corresponding to the set of interrogatories or requests associated with the one or more discovery devices based on result of correlation.

In an embodiment of the present disclosure, the response determination module 218 determines if the received request is served in conjunction with one or more other requests or interrogatories based on the one or more responses by using the document management-based AI model. Further, the response determination module 218 determines a status response corresponding to the one or more non-form devices based on the set of rules, the predefined device information, the determined one or more discovery devices, the generated one or more discovery documents, the one or more responses and the received request by using the document management-based AI model. In an exemplary embodiment of the present disclosure, the status response is admit, deny, unable to admit or deny. In an embodiment of the present disclosure, the determined status response is inserted in the one or more responses corresponding to the one or more non-form devices. Furthermore, the response determination module 218 receives one or more bases from the one or more responding users or the responding client for refusal to admit associated with the one or more responses corresponding to the one or more form devices. In an embodiment of the present disclosure, the one or more bases are reasons for the refusal to admit, per FROGS 17.1/FROGSE 217.1: (a) state the number of the request; (b) state all facts upon which you base your response; (c) state the names, addresses, and telephone numbers of all persons who have knowledge of those facts; and (d) identify all documents and other tangible things that support your response and state the name, address, and telephone number of the person who has each document or thing. The response determination module 218 inserts the received one or more bases into the one or more responses corresponding to the one or more form devices. For example, if California state court RFAS are propounded in conjunction with FROGS (with No. 17.1 selected) or FROGSE (with No. 217.1 selected), the client is required to provide bases for every RFA they refuse to “admit.” Instead of waiting until the client responds to the FROGS/FROGSE, the client is asked for their bases while they're answering the RFAS. In another example, if CA state court RFAS propounded in conjunction with FROGS (with No. 17.1 selected) or FROGSE (with No. 217.1 selected). the responses i.e., admit, deny, unable to admit or deny, are inserted into the response to the RFAS and puts the client's bases for their refusal to admit into the response to the FROGS/FROGSE. FROGS No, 17.1 states that FROGS No. 17.1 states that “is your response to each request for admission served with these interrogatories an unqualified admission? If not, for each response that is not an unqualified admission: (a) state the number of the request; (b) state all facts upon which you base your response; (c) state the names, ADDRESSES, and telephone numbers of all PERSONS who have knowledge of those facts; and (d) identify all DOCUMENTS and other tangible things that support your response and state the name, ADDRESS, and telephone number of the PERSON who has each DOCUMENT or thing. In an embodiment of the present disclosure, it is determined if specific language is required in response to a question based on the predefined device information and the one or more responses by using the document management-based AI model. For example, if the client lacks documents responsive to a California state RPDS, the response must state that the client made a diligent search and reasonable inquiry in an effort to comply with the demand. In such case, the response is prepended with that language. In an embodiment of the present disclosure, format of the POS required in a specific jurisdiction is determined based on the predefined device information, the case number, the letterhead and the service list to create a completed POS by using the document management-based AI model. The completed POS may be signed with a mouse click.

Further, in determining the one or more responses corresponding to the set of interrogatories or requests associated with the one or more discovery devices based on the set of rules, the predefined device information, the determined one or more discovery devices, the generated one or more discovery documents and the received request by using the document management-based AI model upon performing the one or more operations, the response determination module 218 receives one or more discovery responses for the set of interrogatories or requests in the one or more discovery devices from the one or more responding users. In an exemplary embodiment of the present disclosure, the one or more discovery responses include an addition, a deletion, a replacement or any combination thereof of a written content in the one or more discovery devices. For example, it is determined if discovery is form or non-form. If the discovery is a “non-form” device, i.e., RFAS, SROGS, or RPDS, text boxes are offered to the one or more responding users or the responding client into which they can enter their responses. The one or more responding users may object to any or all of the set of interrogatories or requests, including subparts for form interrogatories. The document management-based AI model offers a library of common objections that the user may insert with a click. In an embodiment of the present disclosure, the one or more responding questions may answer any question in the one or more discovery devices. In an embodiment of the present disclosure, the one or more responding users may collaborate with their clients by providing instructions, such as “Don't answer No. 2, I'll handle it” or “Please provide a more detailed response to No. 216.1. For example, when a client is invited to collaborate on the one or more discovery responses, the client's email address is checked in the storage unit 206. If the email address is not found in the storage unit 206, it is requested from the user and saved for future references. Further, the client is invited via an email to respond. A link in the email allows the client limited access to discovery and responses. In an embodiment of the present disclosure, objections are concealed from the client to avoid clutter because clients can't object. For each question, amount of information to be displayed is limited based on the predefined device information. For example, the client is only required to answer California state FROGSE Nos. 210.2 through 210.6 if their response to No. 210.1 is “Yes,” so it hides Nos. 210.2 through 210.6 unless the client responds affirmatively to No. 210.1. The response determination module 218 identifies one or more keywords, one or more sentences, and one or more parts of the one or more sentences in the received one or more discovery responses based on one or more predefined ranking rules and the predefined device information by using the document management-based AI model. Furthermore, the response determination module 218 ranks each of the identified one or more keywords, the identified one or more sentences, and the identified one or more parts of the one or more sentences based on the one or more predefined ranking rules and the predefined device information by using the document management-based AI model. The response determination module 218 generates the one or more responses corresponding to the set of interrogatories or requests based on the set of rules, the predefined device information, the determined one or more discovery devices, the generated one or more discovery documents, and the received request by using the document management-based AI model upon ranking each of the identified one or more keywords, the identified one or more sentences, and the identified one or more parts of the one or more sentences. The one or more responses are one or more code compliant alternative sentences for updating the one or more discovery responses. For example, if the client doesn't have any documents responsive to a California state RPD, they must state following reasons for this: 1) such documents have never existed; 2) they existed but have been destroyed, lost, misplaced, or stolen; or 3) they are believed to exist, but the client doesn't have them. To ensure that the client provides a code-compliant response, the response determination module 218 offers them a dropdown list of proper responses, rather than just a blank to fill in. In an embodiment of the present disclosure, each one or more responses are checked against the set of rules to see if the one or more responses requires further responses. For example, if the client responds to a California state RPD stating that they believe responsive documents exist, but the client doesn't possess them, the client is required to provide the name and address of any person or organization believed to have them. The client is prompted for this information.

The document generation module 220 is configured to generate one or more additional response documents based on the set of rules, the predefined device information, the determined one or more discovery devices, the generated one or more discovery documents and the received request by using the document management-based AI model. In generating the one or more additional response documents based on the set of rules, the predefined device information, the determined one or more discovery devices, the generated one or more discovery documents and the received request by using the document management-based AI model, the document generation module 220 determines if the one or more additional response documents are required corresponding to the determined one or more discovery documents in a jurisdiction based on the set of rules, the predefined device information, the determined one or more discovery devices, the generated one or more discovery documents and the received request by using the document management-based AI model. Further, the document generation module 220 obtains additional information associated with the one or more additional response documents from the one or more responding users, the responding client via the one or more responding devices 108, the storage unit 206 or a combination thereof upon determining that the one or more additional response documents are required. In an exemplary embodiment of the present disclosure, the additional information includes case number, case name, plaintiffs and defendants, letterhead, parties, jurisdiction of case, service list or any combination thereof. Furthermore, the document generation module 220 generates the one or more additional response documents based on the set of rules, the predefined device information, the determined one or more discovery devices, the generated one or more discovery documents, the obtained additional information and the received request by using the document management-based AI model. For example, when the client returns their responses to their attorney, the set of rules and the predefined device information is checked to determine if additional client documents are required in that Jurisdiction, such as a signed verification. Further, necessary information is gathered to create the verification form, which the client may sign and return with a click. In an embodiment of the present disclosure, when the client returns their discovery responses, their invitation to collaborate on responses to that piece of discovery is deleted to prevent the client from overwriting future work by their attorney. This collaboration cycle may be repeated as necessary. For example, after reviewing the client's answers, the attorney can make comments or suggestions, then invite the client to collaborate again to add to or change their responses. When the attorney is satisfied with the one or more responses, they serve them upon all other parties. In an embodiment of the present disclosure, it is determined what additional document is required for service in that Jurisdiction, such as a verification. For example, if a verification or other doc is required, it is determined if the verification already exists. If not, the attorney/user is notified to request the verification from the client.

The data output module 222 is configured to output the determined one or more responses and the generated one or more additional response documents on user interface screen of the one or more propounding devices 102 associated with the one or more propounding users. In an embodiment of the present disclosure, the determined one or more responses and the generated one or more additional response documents are also outputted to all individuals on the service list. In an embodiment of the present disclosure, the one or more responses are outputted to the one or more responding devices 102 via a navigable link for receiving one or more further updates in real-time. Further, one or more alert notifications are outputted on the user interface screen of the one or more propounding devices 102 if the navigable link is not accessed by the propounding client. In an embodiment of the present disclosure, one on more alert notification are generated only for clients within a first predefined duration. Also, the one or more alert notifications are outputted to the attorneys if the one or more responses are not received within a second predefined duration. The one or more alert notifications are also outputted to the attorneys for one or more upcoming deadlines.

When the propounding one or more users receive the opposing party's responses to the propounded discovery, the propounding one or more users frequently create and serve a “Meet & Confer letter” wherein the propounding one or more users dispute the respondent's objections and/or insufficient responses and demand that the respondent withdraw its objections and/or provide supplemental responses to the propounded discovery. In an embodiment of the present disclosure, the document generation module 220 determines a formatting and a set of content issues for generating a meet and confer letter based on the generated one or more propounded documents, response documents, the one or more additional response documents, the set of rules and the predefined device information by using the document management-based AI model. The formatting and the set of content issues are determined based on the case's jurisdiction. In an embodiment of the present disclosure, the one or more responses usually include refusals to provide information, documents or a combination thereof based upon objections. The one or more propounding users i.e., propounding attorney sends the one or more responding users i.e., responding attorney the “meet & confer letter” containing legal authority and argument that the propounding attorney is entitled to the information and demands a supplemental response providing the missing information or the documents. Further, the document generation module 220 obtains the set of interrogatories or requests and the one or more responses corresponding to the set of interrogatories or requests for discovery at issue from the storage unit 206. The document generation module 220 generates the meet and confer document based on the determined formatting, the determined set of content issues, the obtained set of interrogatories, the obtained one or more responses and the predefined device information by using the document management-based AI model. In an exemplary embodiment of the present disclosure, the meet and confer document include case's letterhead, the propounded interrogatories or requests, the responses provided, and an area where the one or more propounding user can insert the legal arguments supporting the demand for withdrawal of objections or supplementation of responses. The document management-based AI model provides sample authoritative legal arguments that the one or more propounding users can insert into their argument with a mouse click. In an embodiment of the present disclosure, the one or more propounding users may make changes to the generated meet and confer letter, such as by deleting a response if they do not disagree with it or seek a supplementation of it

The response generation module 224 is configured to generate a set of responses for the generated meet and confer document based on the set of rules, the predefined device information, the legal arguments for withdrawal of objections or supplementation of responses, the determined one or more discovery devices, the generated one or more discovery documents and the received request by using the document management-based AI model. In an embodiment of the present disclosure, the set of responses are dependent on the case's jurisdiction and discovery device used, such as FROGS, RFAS and the like. For example, if in California state court, a respondent refused to answer an interrogatory on the grounds that “It calls for a legal conclusion,” the response generation module 224 allows the user to insert an authoritative response, “‘Calls for a legal opinion or conclusion’ is not a valid objection to a request for admission. When a party is served with a request for admission concerning a legal question properly raised in the pleadings, the party cannot object simply by asserting that the request calls for a conclusion of law. The party should make the admission if he is able to do so and does not in good faith intend to contest the issue at trial, thereby ‘setting at rest a triable issue. Otherwise, the party should set forth in detail the reasons why he cannot truthfully admit or deny the request.” The generated Meet & Confer letter also includes a sample demand for supplementation of the responses.

In an embodiment of the present disclosure, when an attorney is satisfied with the meet and confer letter, they can serve it. Further, service requirement in that jurisdiction is determined based on the predefined device information and the generated meet and cover letter by using the document management-based AI model. If additional documents are required corresponding to the meet and confer letter, it is determined if the additional documents already exist. If not, the additional documents are created for the attorney or user and allows them to sign with a click. In an embodiment of the present disclosure, format of the POS required in the jurisdiction is determined based on the predefined device information, the case number, the letterhead and the service list to create a completed POS by using the document management-based AI model. The completed POS may be signed with a mouse click. In an embodiment of the present disclosure, the generated meet and confer letter is “served,” i.e. electronically sent to all the individuals on the service list.

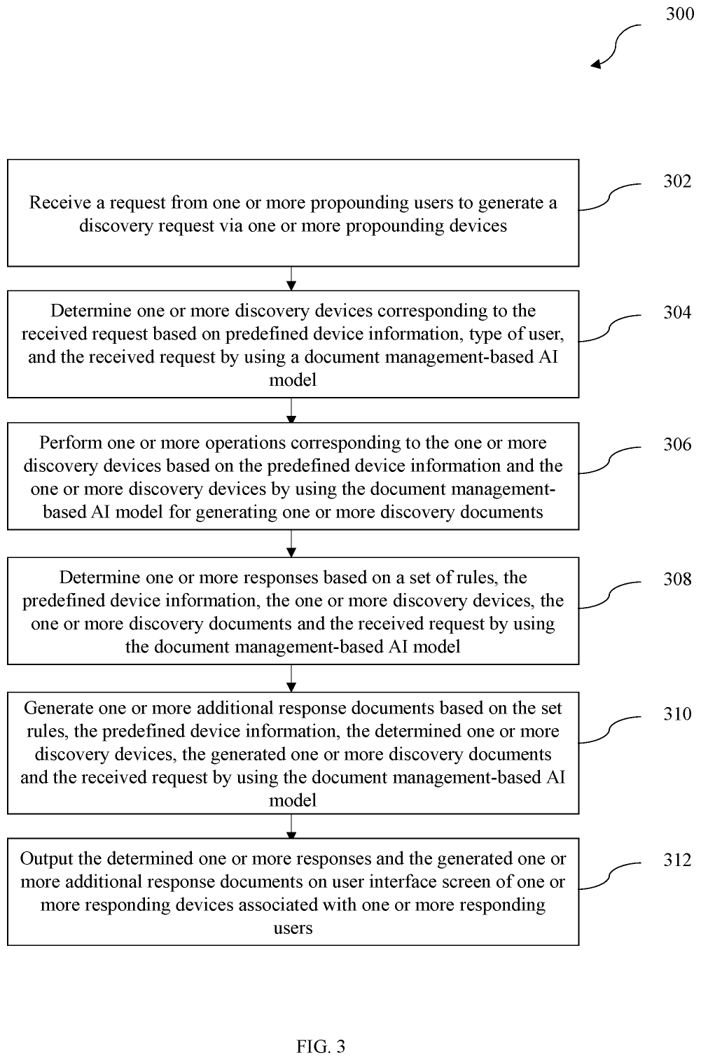

FIG. 3 is a process flow diagram illustrating an exemplary method 300 for processing discovery documents in the legal industry, in accordance with an embodiment of the present disclosure. At step 302, a request is received from one or more propounding users to generate a discovery request via one or more propounding devices 102. In an embodiment of the present disclosure, the one or more propounding users may include propounding firm, their clients or a combination thereof which send a discovery to the opposing side for a response. The discovery is a process in a civil lawsuit where each side gets to ask questions from opposing side. In an exemplary embodiment of the present disclosure, the one or more propounding devices 102 may include a laptop computer, desktop computer, tablet computer, smartphone, wearable device, smart watch, and the like. In an exemplary embodiment of the present disclosure, the request includes case number, case name, plaintiffs and defendants, trial and discovery cut-off dates, lead counsel, letterhead, parties, case team, jurisdiction of case, user data, service list, or a combination thereof. In an embodiment of the present disclosure, the discovery request corresponds to a set of interrogatories or requests in one or more discovery devices. In an exemplary embodiment of the present disclosure, the user data may include user id, password, name, contact details and the like of the one or more propounding users. In an embodiment of the present disclosure, the one or more propounding users may select a case from their case list for generating the discovery request for the case. The case list is a list of all cases in which the one or more propounding users are members of the case's team.

In an embodiment of the present disclosure, before selecting the case from the case list, the case must be created. The method 300 includes receiving the user data from one or more users. In an embodiment of the present disclosure, the one or more users may be the one or more propounding users. Further, the method 300 includes determining if the one or more users are allowed to create the case based on the received user data and the predefined discovery information by using a document management-based AI model. In an embodiment of the present disclosure, an attorney, a support person in the attorney's team or a combination thereof is allowed to create the case. The attorney has a team of professionals, such as other attorneys or support staff, who commonly work on cases with him. Further, the method 300 includes outputs a form for receiving case information from the one or more users upon determining that the one or more users are allowed to create the case. In an exemplary embodiment of the present disclosure, the form includes a set of fields, such as case number, case name, plaintiffs and defendants, letterhead, parties, service list and the like. For example, the lead counsel is the primary attorney handling the case. The lead counsel may be a user creating the case. In an embodiment of the present disclosure, all questions i.e., requests or interrogatories and responses issued in the case use the case's Letterhead, regardless of who created it. This facilitates the use of pool paralegals and contract attorneys, both of which perform work for multiple attorneys. In an embodiment of the present disclosure, all members of the case's team have equal access to the case information for the party they represent. When the case is created, it inherits the lead counsel's team as the case's team. However, case team members may add or delete people from the case's team. Further, the service list discloses name of one or more individuals to whom all documents associated with the case are to be served. In an embodiment of the present disclosure, when the one or more users enter the case number in the form, the method 300 includes determining if the case has already been created. When the case has already been created, the one or more users are provided with an option to either request to join the existing case representing a party or continue creating a new case. In an embodiment of the present disclosure, the cases numbers may include text. In an embodiment of the present disclosure, digits of the cases are matched to determine if the case has already been created. In an embodiment of the present disclosure, if the one or more users request to join the existing case, the one or more users designate the party they represent. Further, one or more emails are shared with everyone on that party's case team, allowing any of them to grant the request. In an embodiment of the present disclosure, when the one or more users enter trial date in the form, the method 300 includes determining the discovery cutoff date based on the trial date and the predefined device information by using the document management-based AI model. For example, in California state cases, the discovery cutoff date is 30 days before the Trial date, adjusting for weekends and court holidays. For example, the method 300 includes determining if the one or more users are the attorney or if the one or more users are a member of any attorney's team. Further, the method 300 includes providing a dropdown list including the user, if they're an attorney, or member of any attorney's team. The one or more users select the case's lead counsel from the dropdown list. When the case is saved, the method 300 includes creating the letterhead of the case from the lead counsel's letterhead. In an embodiment of the present disclosure, future changes to the letterhead do not affect the lead counsel's letterhead. Furthermore, the one or more users add the parties to the case including their name, role, and their representation. For example, the role may be .e., plaintiff, defendant, and the like. For example, the representation may the user's law firm, another attorney, or Pro Per. If the user represents the party, the Party's email address is required to collaborate with the party. In an embodiment of the present disclosure, the service list includes name, email, and party affiliation of the one or more individuals to whom legal documents are required to be served.

At step 304, the one or more discovery devices are determined corresponding to the received request based on a predefined device information, type of user, and the received request by using the document management-based AI model. In an embodiment of the present disclosure, the document management-based AI model may be a ML model. In an embodiment of the present disclosure, each of the one or more discovery devices includes the set of interrogatories or requests. In an embodiment of the present disclosure, the type of user may be determined based on the user data. Users may be either attorneys or non-attorneys (paralegals, secretaries, etc.). Therefore, in an exemplary embodiment, the type of user includes an attorney and support staff. Thereby, an attorney access and a support staff access are determined for the attorney and the support staff, respectively, based on the received user data. In an embodiment of the present disclosure, the clients are sent a link that allows them to respond to discovery. In an embodiment of the present disclosure, the differences between attorneys and non-attorneys i.e., the support staff are that only an attorney or a non-attorney who is a member of an attorney's team can create a case. Further, only attorneys can be lead counsel. Furthermore, some forms, such as a declaration for additional discovery in California state court must be signed by an attorney. All members of a case's team have equal rights to create, edit, delete, and serve discovery requests and responses. In an exemplary embodiment of the present disclosure, the one or more discovery devices for California include FROGS, FROGSE, RFAS, SROGS, RPDS and the like. The RPDS may also be known as request for inspection of things. In an embodiment of the present disclosure, the FROGS allows the one or more propounding users to select pre-created questions. In an embodiment of the present disclosure, the FROGSE is similar to the FROGS, but the questions relate to employment issues. In RFAS, the one or more propounding users create requests asking the responding party to admit to. Further, in SROGS, the one or more propounding users create questions to ask responding party to answer. In RPDS, the one or more propounding users may ask the responding party for specific documents or to inspect items or real property. Further, the set of interrogatories or requests are a set of questions which the one or more propounding users administer on the responding party. The predefined device information includes a set of legal rules, case information, user information, discovery information, court holidays for every supported jurisdiction, a set of jurisdiction rules, a set of form devices used in every supported jurisdiction, a library of definitions of words and phrases used in discovery, a library of objections available in every jurisdiction for specific discovery device, one or more objection killers and the like. For example, the set of rules include all rules corresponding to both statutory and common law controlling the discovery in every supported jurisdiction. The jurisdiction is federal, state, and county (state) or district (federal) where a case is being litigated. The case information includes case numbers, case names, plaintiffs and defendants, trial and discovery cut-off dates, lead counsels, and the like. Further, the user information includes name of client, name of attorney, contact details of client and the like. The discovery information includes documents associated with discovery, interrogatories or requests and the like. In an embodiment of the present disclosure, the set of form devices correspond to discovery forms used in every supported jurisdiction. Furthermore, the one or more objection killers are a library of legal authority in the jurisdiction which invalidate boilerplate objections. In an embodiment of the present disclosure, the one or more responding users or the responding client must respond to the set of interrogatories or requests in writing. For example, the one or more responding users may include responding firm, their client or a combination thereof which provides one or responses for the discovery shared by the one or more propounding users. In an embodiment of the present disclosure, an interface to offer the one or more propounding users is determined based on the predefined device information.

At step 306, one or more operations corresponding to the determined one or more discovery devices are performed based on the predefined device information and the determined one or more discovery devices by using the document management-based AI model for generating the one or more discovery documents. In an embodiment of the present disclosure, the one or more discovery devices may be stored in a storage unit 206. In an exemplary embodiment of the present disclosure, the one or more discovery documents include one or more form devices, one or more non-form devices, one or more ancillary documents, one or more additional documents, POS, and the like. In an embodiment of the present disclosure, the one or more discovery devices and the one or more discovery documents are outputted to one or more responding devices 108 associated with the one or more responding users. In an exemplary embodiment of the present disclosure, the one or more responding devices 108 may include a laptop computer, desktop computer, tablet computer, smartphone, wearable device, smart watch, and the like. In performing the one or more operations corresponding to the determined one or more discovery devices based on the predefined device information and the determined one or more discovery devices by using the document management-based AI model for generating the one or more discovery documents, the method 300 includes receiving a set of form inputs corresponding to the determined one or more discovery devices from the one or more propounding users. In an embodiment of the present disclosure, the set of form inputs correspond to selection of the one or more form devices or the one or more non-form devices from the determined one or more discovery devices. In an exemplary embodiment of the present disclosure, the one or more form devices include FROGS and FROGSE. The one or more non-form devices include RFAS, SROGS and RPDS. Furthermore, the method 300 includes receiving one or more interrogatories or requests inputs from the one or more propounding users to select the set of interrogatories or requests associated with the one or more form devices when the set of form inputs corresponds to the selection of the one or more form devices. For example, the one or more form devices are outputted to the one or more propounding users to select eight interrogatories by providing the one or more interrogatories inputs, such that the one or more responding users or the responding client may respond to the eight interrogatories. The one or more users may also de-select interrogatories. The method 300 includes determining if the selected set of interrogatories or requests affect one or more other interrogatories or requests in the one or more form devices based on the received request and the predefined device information by using the document management-based AI model. For example, FROGS Nos. 6.2-6.7 are only selectable if No. 6.1 has been selected. The method 300 includes generating a set of text boxes corresponding to the one or more non-form devices for receiving response to the set of interrogatories when the set of form inputs corresponds to the selection of the one or more non-form devices. In an exemplary embodiment of the present disclosure, the set of text boxes are generated for entering questions, requests, interrogatories or a combination thereof by the one or more propounding users. Further, the method 300 includes determining one or more definitions that may be inserted into the selected one or more form devices and the selected one or more non-form devices based on the received request and the predefined device information by using the document management-based AI model. In an embodiment of the present disclosure, it is also determined if the one or more definitions are permitted for the selected one or more form devices or the selected one or more non-form devices in a particular jurisdiction. The method 300 includes generating the one or more ancillary documents corresponding to the selected one or more form devices or the selected one or more non-form devices based on one or more ancillary parameters, the received request and the predefined device information by using the document management-based AI model. In an embodiment of the present disclosure, it is also determined if the one or more ancillary documents are required based on the predefined device information before generating the one or more ancillary documents. In an exemplary embodiment of the present disclosure, the one or more ancillary parameters include number of interrogatories, number of interrogatories or requests sent previously and type of discovery devices. For example, if more than 35 RFAS or SROGS have been issued by same propounding i.e., issuing party to same respondent i.e., responding party in California state court, a DAD is required. Further, the DAD is created, such that a user can sign it. The method 300 includes determining one or more signature requirements corresponding to the one or more form devices and the one or more non-form devices based on the received request and the predefined device information by using the document management-based AI model. For example, the one or more signature requirements may be that an attorney's or client's signature is required on a form device. In another example, in California state court, the DAD can only be signed by an attorney. If the user isn't an attorney, it is instructed to the user to have an attorney on this case team sign it. Further, the method 300 includes determining one or more formats required for the POS for generating the POS based on the received request and the predefined device information by using the document management-based AI model. For example, information, such as the case number, case's letterhead, service list and the like, is obtained from the storage unit 206 to create a completed POS that the user can sign with a mouse click. In an embodiment of the present disclosure, user is prompted to pay for service for generating the discovery request. Further, the one or more discovery documents in served to the one or more individuals on the service list. The method 300 includes determining the one or more additional documents required for the selected one or more form devices and the selected one or more non-form devices based on the received request and the predefined device information by using the document management-based AI model. For example, it is determined if in the current jurisdiction, the selected one or more form devices or the selected one or more non-form devices is commonly propounded in conjunction with another device. In the California state court, the RFAS are propounded in conjunction with FROGS or FROGSE in order to force respondent to provide bases for their refusals to admit any RFA. If such an additional device is found, the user is prompted to create it, and links the two devices in the storage unit 206, such that when devices are being responded to, the document management-based AI model is aware of and enforces their connection.

At step 308, one or more responses corresponding to the set of interrogatories, or requests associated with the one or more discovery devices are determined based on a set of rules for a jurisdiction where litigation is taking place, the predefined device information, the determined one or more discovery devices, the generated one or more discovery documents and the received request by using the document management-based AI model upon performing the one or more operations. For example, using the document management-based AI model to respond requires that the requests or interrogatories are in the storage unit 206. If the discovery was propounded via the document management-based AI model, that's automatic. If not, the document management-based AI model allows the one or more responding users to easily recreate the requests or interrogatories. In an exemplary embodiment of the present disclosure, the one or more responses include reasons of not having documents responsive to an RPD, one or more questions, one or more answers to the one or more questions and the set of interrogatories, a name and an address of a person or an organization, a specific language required in response to a question or any combination thereof. In determining the one or more responses corresponding to the set of interrogatories or requests associated with the one or more discovery devices based on the set of rules, the predefined device information, the determined one or more discovery devices and the received request by using the document management-based AI model upon performing the one or more operations, the method 300 includes correlating the set of rules, the predefined device information, the determined one or more discovery devices and the received request by using the document management-based AI model. Further, the method 300 includes determining the one or more responses corresponding to the set of interrogatories or requests associated with the one or more discovery devices based on result of correlation.

In an embodiment of the present disclosure, the method 300 includes determining if the received request is served in conjunction with one or more other requests based on the one or more responses by using the document management-based AI model. Further, the method 300 includes determining a status response corresponding to the one or more non-form devices based on the set of rules, the predefined device information, the determined one or more discovery devices, the generated one or more discovery documents, the one or more responses and the received request by using the document management-based AI model. In an exemplary embodiment of the present disclosure, the status response is admit, deny, unable to admit or deny. In an embodiment of the present disclosure, the determined status response is inserted in the one or more responses corresponding to the one or more non-form devices. Furthermore, the method 300 includes receiving one or more bases from the one or more responding users or the responding client for refusal to admit associated with the one or more responses corresponding to the one or more form devices. The method 300 includes inserting the received one or more bases into the one or more responses corresponding to the one or more form devices. In an embodiment of the present disclosure, it is determined if specific language is required in response to a question based on the predefined device information and the one or more responses by using the document management-based AI model. In an embodiment of the present disclosure, format of the POS required in a specific jurisdiction is determined based on the predefined device information, the case number, the letterhead and the service list to create a completed POS by using the document management-based AI model.

Further, in determining the one or more responses corresponding to the set of interrogatories or requests associated with the one or more discovery devices based on the set of rules, the predefined device information, the determined one or more discovery devices, the generated one or more discovery documents and the received request by using the document management-based AI model upon performing the one or more operations, the method 300 includes receiving one or more discovery responses for the set of interrogatories or requests in the one or more discovery devices from the one or more responding users. In an exemplary embodiment of the present disclosure, the one or more discovery responses include an addition, a deletion, a replacement or any combination thereof of a written content in the one or more discovery devices. For example, it is determined if discovery is form or non-form. If the discovery is a “non-form” device, i.e., RFAS, SROGS, or RPDS, text boxes are offered to the one or more responding users or the responding client into which they can enter their answers. The one or more responding users may object to any or all of the set of interrogatories, including subparts for form interrogatories. The document management-based AI model offers a library of common objections that the user may insert with a click. The method 300 includes identifying one or more keywords, one or more sentences, and one or more parts of the one or more sentences in the received one or more discovery responses based on one or more predefined ranking rules and the predefined device information by using the document management-based AI model. Furthermore, the method 300 includes ranking each of the identified one or more keywords, the identified one or more sentences, and the identified one or more parts of the one or more sentences based on the one or more predefined ranking rules and the predefined device information by using the document management-based AI model. The method 300 includes generating the one or more responses corresponding to the set of interrogatories or requests based on the set of rules, the predefined device information, the determined one or more discovery devices, the generated one or more discovery documents, and the received request by using the document management-based AI model upon ranking each of the identified one or more keywords, the identified one or more sentences, and the identified one or more parts of the one or more sentences. The one or more responses are one or more code compliant alternative sentences for updating the one or more discovery responses.

At step 310, one or more additional response documents are generated based on the set of rules, the predefined device information, the determined one or more discovery devices, the generated one or more discovery documents and the received request by using the document management-based AI model. In generating the one or more additional response documents based on the set of rules, the predefined device information, the determined one or more discovery devices, the generated one or more discovery documents and the received request by using the document management-based AI model, the method 300 includes determining if the one or more additional response documents are required corresponding to the determined one or more discovery documents in a jurisdiction based on the set of rules, the predefined device information, the determined one or more discovery devices, the generated one or more discovery documents and the received request by using the document management-based AI model. Further, the method 300 includes obtaining additional information associated with the one or more additional response documents from the one or more responding users, the responding client via the one or more responding devices 108, the storage unit 206 or a combination thereof upon determining that the one or more additional response documents are required. In an exemplary embodiment of the present disclosure, the additional information includes case number, case name, plaintiffs and defendants, trial and discovery cut-off dates, lead counsel, letterhead, parties, case team, jurisdiction of case, address of clients, contact details of the clients, service list or any combination thereof. Furthermore, the method 300 includes generating the one or more additional response documents based on the set of rules, the predefined device information, the determined one or more discovery devices, the generated one or more discovery documents, the obtained additional information and the received request by using the document management-based AI model. For example, when the client returns their responses to their attorney, the set of rules and the predefined device information is checked to determine if additional client documents are required in that Jurisdiction, such as a signed verification.

At step 312, the determined one or more responses and the generated one or more additional response documents are outputted on user interface screen of the one or more responding devices 102 associated with the one or more responding users. In an embodiment of the present disclosure, the determined one or more responses and the generated one or more additional response documents are also outputted to all individuals on the service list. In an embodiment of the present disclosure, the one or more responses are outputted to the one or more responding devices 102 via a navigable link for receiving one or more further updates in real-time. Further, one or more alert notifications are outputted on the user interface screen of the one or more responding devices 102 if the navigable link is not accessed by the one or more responding users.

In an embodiment of the present disclosure, the method 300 includes determining a formatting and a set of content issues for generating a meet and confer document based on the generated one or more propounded documents, response documents, one or more additional response documents, the set of rules and the predefined device information by using the document management-based AI model. The formatting and the set of content issues are determined based on the jurisdiction of discovery. In an embodiment of the present disclosure, the one or more responses usually include refusals to provide information, documents or a combination thereof based upon objections. The one or more propounding users i.e., propounding attorney sends the one or more responding users i.e., responding attorney the “meet & confer letter” containing legal authority and argument that the propounding attorney is entitled to the information and demands a supplemental response providing the missing information or the documents. Further, the method 300 includes obtaining the set of interrogatories or requests and the one or more responses corresponding to the set of interrogatories or requests for discovery at issue from the storage unit 206. The method 300 includes generating the meet and confer document based on the determined formatting, the determined set of content issues, the obtained set of interrogatories, the obtained one or more responses and the predefined device information by using the document management-based AI model. In an exemplary embodiment of the present disclosure, the meet and confer document include case's letterhead, a set of questions, names, addresses of parties and the like. In an embodiment of the present disclosure, the one or more propounding users may make changes to the generated meet and confer letter, such as by deleting a question from the generated meet and confer letter if not required, inserting a response and the like. In an embodiment of the present disclosure, the questions and responses are displayed along with an area for the propounding attorney for receiving responses.

Further, the method 300 includes generating a set of responses for the generated meet and confer document based on the set of rules, the predefined device information, the determined one or more discovery devices, the generated one or more discovery documents and the received request by using the document management-based AI model. In an embodiment of the present disclosure, the set of responses are dependent on the jurisdiction of the discovery and discovery device used, such as FROGS, RFAS and the like. If additional documents are required corresponding to the meet and confer letter, it is determined if the additional documents already exist. If not, the additional documents are created for the attorney or user and allows them to sign with a click. In an embodiment of the present disclosure, the generated meet and confer letter is outputted to all the individuals on the service list.

The method 300 may be implemented in any suitable hardware, software, firmware, or combination thereof.

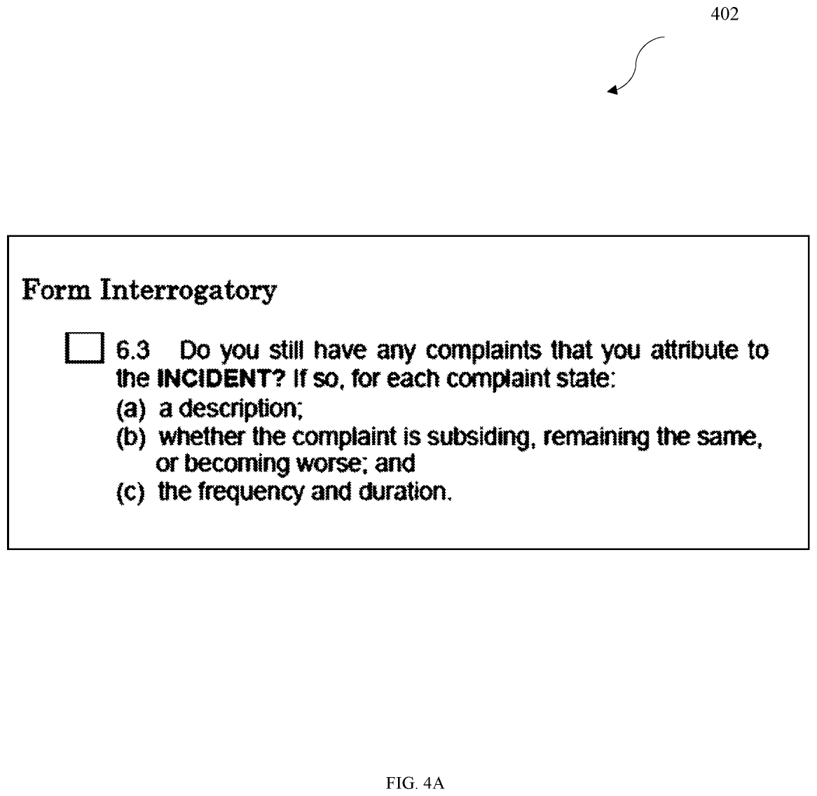

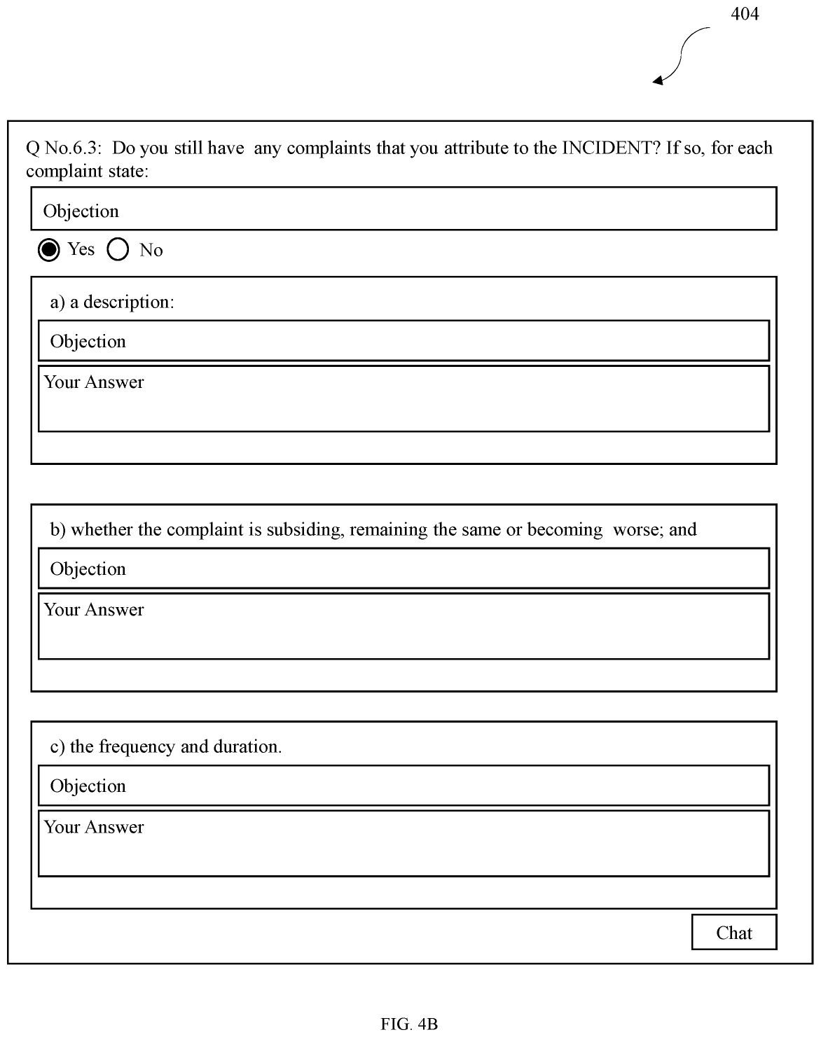

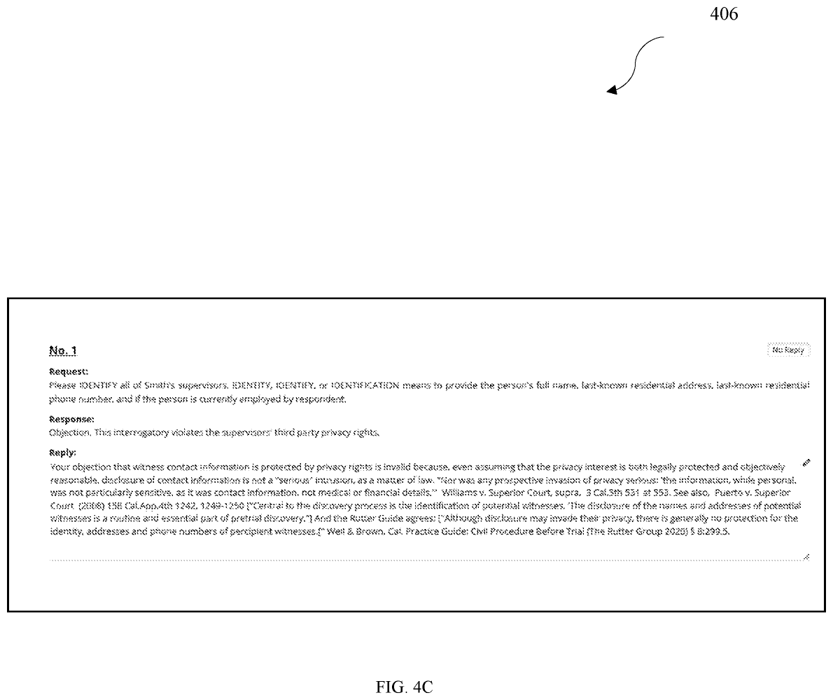

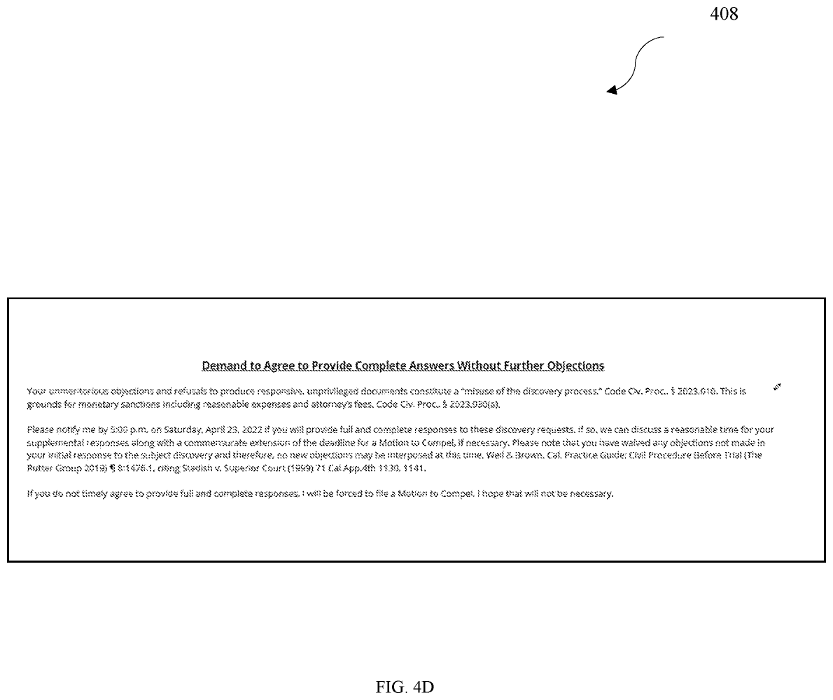

FIG. 4A is an exemplary portion of a form interrogatory 402 for receiving one or more responses, in accordance with an embodiment of the present disclosure. In an embodiment of the present disclosure, the form interrogatory 402 is a form device. The form interrogatory 402 includes a discovery request having a set of pre-created questions created by an attorney on a paper document. The attorney sends the form interrogatory to their clients for discovery requests and the clients respond to the questions on a separate piece of paper. The response to the questions is sent back to the attorney.

FIG. 4B is an exemplary portion of the form interrogatory 404 for receiving the one or more responses, in accordance with another embodiment of the present disclosure. In an embodiment of the present disclosure, FIG. 4B displays questions or query in the form interrogatory 404, such as—form interrogatory (FROGS or FROGSE), to the client in a customized format that allows the client to enter their responses in real time in the document itself, rather than in a separate document. In this manner, the present disclosure guides the client to provide one or more responses to all of the questions or queries, including one or more subparts, clearly and separately.

FIG. 4C is an exemplary form interrogatory depicting formatting and set of content issues 406, in accordance with an embodiment of the present.

FIG. 4D is an exemplary form interrogatory depicting sample demand 408 for supplementation of the responses, in accordance with another embodiment of the present disclosure.

Thus, various embodiments of the present computing system 104 provide a solution to process discovery documents in a legal industry. In an embodiment of the present disclosure, the computing system 104 performs paralegal activities involved in responding a discovery process for one or more users. The computing system 104 facilitates collaboration between the service providers and the clients anywhere in the world for a document management of the discovery process. The computing system 104 simplifies document management of the discovery process and makes one or more activities involved in document management of the discovery process resistant to mistakes. The computing system 104 facilitates the users to insert objections including a library of properly cited objections available for the users into responses with a mouse click. When the user is ready to serve the responses upon other users, a filled-in Proof of Service is generated that the user electronically signs with a click or two. Further, the computing system 104 generates discovery by knowing one or more discovery devices or forms available for the discovery in litigating the case in a jurisdiction. The computing system 104 provides a library of definitions of terms readily available for the user to insert into a discovery request. Furthermore, the computing system 104 recognizes when the user needs an additional document, and automatically creates the additional document, based upon the jurisdiction's rules. For example, if a service provider propounds more than thirty-five SROGS or RFAS, a document, namely ‘signed Declaration for Additional Discovery’, needs to be attached, as per the jurisdiction's rules. If the user fails to do so, the client needs only to provide a response to the first thirty-five SROGS or RFAS. Sometimes the user mistakenly forgets to attach the ‘signed Declaration for Additional Discovery’. The computing system 104 prevents the mistake by generating a Declaration for Additional Discovery, whenever the user attempts to serve SROGS or RFAS requiring one. Further, the computing system 104 facilitates the user to electronically sign the Declaration for Additional Discovery. The computing system 104 also retrieves information needed in a form and inserts the information into one or more correct fields, and further facilitates the user to electronically sign the document. When the user is ready to serve the discovery upon one or more other users, a filled-in Proof of Service is generated that the user signs electronically. Furthermore, the clients are generally not from the legal field and therefore, the response received from the clients does not follow the nitty-gritty of code compliance. The present disclosure provides a technical solution for users in providing code-compliant responses to discovery requests without the involvement of any from the law firm. As responses are code-compliant and clearly provided corresponding to each of the subparts separately, it saves the attorney's time put in the clean-up effort.

Further, the rules in many jurisdictions required responses to discovery to include a “verification,” a document signed by the responding client attesting to the truthfulness of the responses. Typically, firms send the client a verification form which the client prints out, signs, and returns to the firm. However, clients frequently forget or otherwise fail to do so, creating a serious problem for the firm because under California law, unverified responses are tantamount to failing to respond, which subjects the responding law firm and/or client to penalties. The present disclosure assists firms in obtaining a signed verification by creating one, completely filled in, that the client can sign and return to the firm with a mouse click, whenever the client returns their responses to the responding firm. Furthermore, the RFAS are optionally served in conjunction with either FROGS or FROGSE. The client's admission or denial goes into a response to the RFAS. If the RFA were served in conjunction with either FROGS with No. 17.1, or FROGSE with No. 217.1 selected, for every RFA the client denies, the present disclosure seeks all of the bases for the denial. The bases for the client's denials are provided in the response to the FROGS or FROGSE. When the client selects “Deny” or “Unable to Admit or Deny” to the RFA, the present disclosure checks the remote server to find if FROGS with No. 17.1 or FROGSE with No. 217.1 selected were propounded in conjunction with the RFAS. If so, the present disclosure receives all of the bases for the client's refusals to admit in real-time, while the client is still responding to the RFAS and puts the bases into the client's response to the FROGS or FROGSE. Further, the present disclosure provides one or more rules for the one or more responses received from a client to the RPDS. The client selects one of the following responses to each document request: 1. I have the document(s); 2. The document(s) have never existed; 3. The document(s) were destroyed; 4. I had the document(s), but they've been lost, stolen, or I lack access to them. If the client selects the 4th response, they are required to identify anyone the client believes to have the documents. Further, as per the rules, the present disclosure adds a statement from the client who doesn't have any responsive documents stating that the client performed a diligent search for responsive documents but was unable to find any. The computing system 104 uses smart forms instead of mere blank lines to guide the client to respond to all of the questions they're required to answer, and to answer them using language required by the rules, i.e. code-compliant.

Furthermore, the computing system 104 receives the one or more discovery responses from the client via unspecified text for response to Special Interrogatories (SROGS). Furthermore, the client is required to verify the correctness of their responses under the penalty of perjury. Therefore, the computing system 104 creates a verification for the client's response. Further, the one or more documents generated are shared to one or more other users via a navigable link for receiving one or more updates in real-time. Additionally, for the document management of the discovery process, users are occasionally required to hold meetings and to confer about discovery responses considered insufficient, evasive, or otherwise improper, i.e. a “Meet and Confer.” The present disclosure assists users in doing so by generating the meet & confer document including all of the questions and answers. The computing system 104 also provides the users with a library of properly cited responses to common objections that the user can insert with a mouse click. The computing system 104 also facilitates a time tracking of the discovery process. The computing system 104 also includes a method for the propounding one or more users to “meet and confer” with the responding one or more users regarding the responses, including the propounding one or more users' legal bases for demanding that objections contained in the one or more responses be withdrawn and/or the responses be supplemented with additional responsive information.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 208 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

1. A computing system for processing discovery documents in a legal industry, the AI-based computing system comprising:
one or more hardware processors; and
a memory coupled to the one or more hardware processors, wherein the memory comprises a plurality of modules in the form of programmable instructions executable by the one or more hardware processors and, wherein the plurality of modules comprises:
a request receiver module configured to receive a request from one or more propounding users to generate a discovery request via one or more propounding devices, wherein the request comprises at least one of: case number, case name, plaintiffs and defendants, lead counsel, letterhead, parties, jurisdiction of case, user data, and service list, and wherein the discovery request corresponds to one of: a set of interrogatories and requests in one or more discovery devices;
a device determination module configured to determine the one or more discovery devices corresponding to the received request based on predefined device information, type of user, and the received request by using a document management-based Artificial Intelligence (AI) model, wherein each of the one or more discovery devices comprises one of: the set of interrogatories and requests;
an operation performing module configured to perform one or more operations corresponding to the determined one or more discovery devices based on the predefined device information and the determined one or more discovery devices by using the document management-based AI model for generating one or more discovery documents, wherein the one or more discovery documents comprise at least one of: one or more form devices, one or more non-form devices, one or more ancillary documents, one or more additional documents and Proof of Service (POS), and wherein the one or more discovery devices and the one or more discovery documents are outputted to one or more responding devices associated with one or more responding users;
a response determination module configured to determine one or more responses corresponding to one of: the set of interrogatories and requests associated with the one or more discovery devices based on a set of rules for a jurisdiction where litigation is taking place, the predefined device information, the determined one or more discovery devices, the generated one or more discovery documents and the received request by using the document management-based AI model upon performing the one or more operations;
a document generation module configured to generate one or more additional response documents based on the set of rules, the predefined device information, the determined one or more discovery devices, the generated one or more discovery documents and the received request by using the document management-based AI model; and
a data output module configured to output the determined one or more responses and the generated one or more additional response documents on user interface screen of the one or more responding devices associated with the one or more responding users.

2. The computing system of claim 1, wherein in performing the one or more operations corresponding to the determined one or more discovery devices based on the predefined device information and the determined one or more discovery devices by using the document management-based AI model for generating the one or more discovery documents, the operation performing module is configured to:
receive a set of form inputs corresponding to the determined one or more discovery devices from the one or more propounding users, wherein the set of form inputs correspond to selection of one of: the one or more form devices and the one or more non-form devices from the determined one or more discovery devices, wherein the one or more form devices comprise Form Interrogatories—General (FROGS) and Form Interrogatories—Employment (FROGSE), and wherein the one or more non-form devices comprise Requests for Admission (RFAS), Special Interrogatories (SROGS) and Requests for Production of Documents (RPDS);
receive one of: one or more interrogatories and requests inputs from the one or more propounding users to select the one of: set of interrogatories or requests associated with the one or more form devices when the set of form inputs corresponds to the selection of the one or more form devices;
determine if one of: the selected set of interrogatories and requests affect one of: one or more other interrogatories and requests in the one or more form devices based on the received request and the predefined device information by using the document management-based AI model;
generate a set of text boxes corresponding to the one or more non-form devices for receiving response to one of: the set of interrogatories and the requests when the set of form inputs corresponds to the selection of the one or more non-form devices;
determine one or more definitions required to be inserted into the selected one or more form devices and the one or more non-form devices based on the received request and the predefined device information by using the document management-based AI model;
generate the one or more ancillary documents corresponding to the selected one or more form devices and the one or more non-form devices based on one or more ancillary parameters, the received request and the predefined device information by using the document management-based AI model, wherein the one or more ancillary parameters comprise number of one of: interrogatories and requests, number of one of: interrogatories and requests sent previously and type of discovery devices;
determine one or more signature requirements corresponding to the selected one or more form devices and the one or more non-form devices based on the received request and the predefined device information by using the document management-based AI model;
determine one or more formats required for the POS for generating the POS based on the received request and the predefined device information by using the document management-based AI model; and
determine the one or more additional documents required for the selected one or more form devices and the one or more non-form devices based on the received request and the predefined device information by using the document management-based AI model.

3. The computing system of claim 1, wherein the predefined device information comprises a set of legal rules, case information, user information, discovery information, court holidays for every supported jurisdiction, a set of jurisdiction rules, a set of form devices used in every supported jurisdiction, a library of definitions of words and phrases used in discovery, one or more objection killers, and a library of objections available in every jurisdiction for specific discovery device, and wherein the one or more responses comprise at least one of: reasons of not having documents responsive to an RPD, one or more questions, one or more answers to the one or more questions and the one of: set of interrogatories and requests, a name and an address of one of: a person and an organization, and a specific language required in response to a question.

4. The computing system of claim 1, wherein in determining the one or more responses corresponding to one of: the set of interrogatories and requests associated with the one or more discovery devices based on the set of rules, the predefined device information, the determined one or more discovery devices and the received request by using the document management-based AI model upon performing the one or more operations, the response determination module is configured to:
correlate the set of rules, the predefined device information, the determined one or more discovery devices and the received request by using the document management-based AI model; and
determine the one or more responses corresponding to one of: the set of interrogatories and requests associated with the one or more discovery devices based on result of correlation.

5. The computing system of claim 1, wherein in generating the one or more additional response documents based on the set of rules, the predefined device information, the determined one or more discovery devices, the generated one or more discovery documents and the received request by using the document management-based AI model, the document generation module is configured to:
determine if the one or more additional response documents are required corresponding to the determined one or more discovery documents in a jurisdiction based on the set of rules, the predefined device information, the determined one or more discovery devices, the generated one or more discovery documents and the received request by using the document management-based AI model;
obtain additional information associated with the one or more additional response documents from at least one of: the one or more responding users, the responding client via the one or more responding devices and a storage unit upon determining that the one or more additional response documents are required, wherein the additional information comprises at least one of: case number, case name, plaintiffs and defendants, lead counsel, letterhead, parties, jurisdiction of case, and service list; and
generate the one or more additional response documents based on the set of rules, the predefined device information, the determined one or more discovery devices, the generated one or more discovery documents, the obtained additional information and the received request by using the document management-based AI model.

6. The computing system of claim 1, wherein the response determination module is configured to:
determine if the received request is served in conjunction with one or more other requests based on the one or more responses by using the document management-based AI model;
determine a status response corresponding to the one or more non-form devices based on the set of rules, the predefined device information, the determined one or more discovery devices, the generated one or more discovery documents, the one or more responses and the received request by using the document management-based AI model, wherein the status response is one of: admit, deny, unable to admit and deny, and wherein the determined status response is inserted in the one or more responses corresponding to the one or more non-form devices;
receive one or more bases from one of: the one or more responding users and the responding client for refusal to admit associated with the one or more responses corresponding to the one or more form devices; and
insert the received one or more bases into the one or more responses corresponding to the one or more form devices.

7. The computing system of claim 1, wherein in determining the one or more responses corresponding to one of: the set of interrogatories and requests associated with the one or more discovery devices based on the set of rules, the predefined device information, the determined one or more discovery devices, the generated one or more discovery documents and the received request by using the document management-based AI model upon performing the one or more operations, the response determination module is configured to:
receive one or more discovery responses for one of: the set of interrogatories and requests in the one or more discovery devices from one of: the one or more responding users and a responding client, wherein the one or more discovery responses comprise at least one of: an addition, a deletion, and a replacement of a written content in the one or more discovery devices;
identify one or more keywords, one or more sentences, and one or more parts of the one or more sentences in the received one or more discovery responses based on one or more predefined ranking rules and the predefined device information by using the document management-based AI model;
rank each of the identified one or more keywords, the identified one or more sentences, and the identified one or more parts of the one or more sentences based on the one or more predefined ranking rules and the predefined device information by using the document management-based AI model; and
generate the one or more responses corresponding to one of: the set of interrogatories and requests based on the set of rules, the predefined device information, the determined one or more discovery devices, the generated one or more discovery documents, and the received request by using the document management-based AI model upon ranking each of the identified one or more keywords, the identified one or more sentences, and the identified one or more parts of the one or more sentences, wherein the one or more responses are one or more code compliant alternative sentences for updating the one or more discovery responses.

8. The computing system of claim 1, wherein the document generation module is configured to:
determine a formatting and a set of content issues for generating a meet and confer document based on the generated one or more propounded documents, response documents, the one or more additional response documents, the set of rules and the predefined device information by using the document management-based AI model;
obtain one of: the set of interrogatories and requests and the one or more responses corresponding to one of: the set of interrogatories and requests for discovery at issue from a storage unit; and
generate the meet and confer document based on the determined formatting, the determined set of content issues, the obtained set of interrogatories, the obtained one or more responses and the predefined device information by using the document management-based AI model, wherein the meet and confer document comprise case's letterhead, a set of questions, names and addresses of parties.

9. The computing system of claim 8, further comprising a response generation module configured to generate a set of responses for the generated meet and confer document based on the set of rules, the predefined device information, the determined one or more discovery devices, the generated one or more discovery documents and the received request by using the document management-based AI model.

10. The computing system of claim 1, wherein the one or more discovery devices comprise FROGS, FROGSE, RFAS, SROGS and RPDS.

11. A method for processing discovery documents in a legal industry, the AI-based method comprising:
receiving, by one or more hardware processors, a request from one or more propounding users to generate a discovery request via one or more propounding devices, wherein the request comprises at least one of: case number, case name, plaintiffs and defendants, lead counsel, letterhead, parties, jurisdiction of case, user data, and service list, and wherein the discovery request corresponds to one of: a set of interrogatories and requests in one or more discovery devices;
determining, by the one or more hardware processors, the one or more discovery devices corresponding to the received request based on predefined device information, type of user, and the received request by using a document management-based Artificial Intelligence (AI) model, wherein each of the one or more discovery devices comprises one of: the set of interrogatories and requests;
performing, by the one or more hardware processors, one or more operations corresponding to the determined one or more discovery devices based on the predefined device information and the determined one or more discovery devices by using the document management-based AI model for generating one or more discovery documents, wherein the one or more discovery documents comprise at least one of: one or more form devices, one or more non-form devices, one or more ancillary documents, one or more additional documents, and Proof of Service (POS), and wherein the one or more discovery devices and the one or more discovery documents are outputted to one or more responding devices associated with one or more responding users;
determining, by the one or more hardware processors, one or more responses corresponding to one of: the set of interrogatories and requests associated with the one or more discovery devices based on a set of rules for a jurisdiction where litigation is taking place, the predefined device information, the determined one or more discovery devices, the generated one or more discovery documents and the received request by using the document management-based AI model upon performing the one or more operations;
generating, by the one or more hardware processors, one or more additional response documents based on the set of rules, the predefined device information, the determined one or more discovery devices, the generated one or more discovery documents and the received request by using the document management-based AI model; and
outputting, by the one or more hardware processors, the determined one or more responses and the generated one or more additional response documents on user interface screen of the one or more propounding devices associated with the one or more propounding users.

12. The method of claim 11, wherein performing the one or more operations corresponding to the determined one or more discovery devices based on the predefined device information and the determined one or more discovery devices by using the document management-based AI model for generating the one or more discovery documents comprises:
receiving a set of form inputs corresponding to the determined one or more discovery devices from the one or more propounding users, wherein the set of form inputs correspond to selection of one of: the one or more form devices and the one or more non-form devices from the determined one or more discovery devices, wherein the one or more form devices comprise Form Interrogatories—General (FROGS) and Form Interrogatories—Employment (FROGSE), and wherein the one or more non-form devices comprise Requests for Admission (RFAS), Special Interrogatories (SROGS) and Requests for Production of Documents (RPDS);
receiving one of: one or more interrogatories and requests inputs from the one or more propounding users to select one of: the set of interrogatories and requests associated with the one or more form devices when the set of form inputs corresponds to the selection of the one or more form devices;
determining if one of: the selected set of interrogatories and requests affect one of: one or more other interrogatories and requests in the one or more form devices based on the received request and the predefined device information by using the document management-based AI model;
generating a set of text boxes corresponding to the one or more non-form devices for receiving response to one of: the set of interrogatories and requests when the set of form inputs corresponds to the selection of the one or more non-form devices;
determining one or more definitions required to be inserted in the selected one of: the one or more form devices and the one or more non-form devices based on the received request and the predefined device information by using the document management-based AI model;
generating the one or more ancillary documents corresponding to the selected one of: the one or more form devices and the one or more non-form devices based on one or more ancillary parameters, the received request and the predefined device information by using the document management-based AI model, wherein the one or more ancillary parameters comprise number of interrogatories, number of one of: interrogatories and requests sent previously and type of discovery devices;
determining one or more signature requirements corresponding to the selected one of: the one or more form devices and the one or more non-form devices based on the received request and the predefined device information by using the document management-based AI model;
determining one or more formats required for the POS for generating the POS based on the received request and the predefined device information by using the document management-based AI model; and
determining the one or more additional documents required for the selected one of: the one or more form devices and the one or more non-form devices based on the received request and the predefined device information by using the document management-based AI model.

13. The method of claim 11, wherein the predefined device information comprises a set of legal rules, case information, user information, discovery information, court holidays for every supported jurisdiction, a set of jurisdiction rules, a set of form devices used in every supported jurisdiction, a library of definitions of words and phrases used in discovery, one or more objection killers, and a library of objections available in every jurisdiction for specific discovery device, wherein the one or more responses comprise at least one of: reasons of not having documents responsive to an RPD, one or more questions, one or more answers to the one or more questions and the set of interrogatories, a name and an address of one of: a person and an organization, and a specific language required in response to a question, and wherein the one or more discovery devices comprise FROGS, FROGSE, RFAS, SROGS and RPDS.

14. The method of claim 11, wherein determining the one or more responses corresponding to one of: the set of interrogatories and requests associated with the one or more discovery devices based on the set of rules, the predefined device information, the determined one or more discovery devices and the received request by using the document management-based AI model upon performing the one or more operations comprises:
correlating the set of rules, the predefined device information, the determined one or more discovery devices and the received request by using the document management-based AI model; and
determining the one or more responses corresponding to one of: the set of interrogatories and requests associated with the one or more discovery devices based on result of correlation.

15. The method of claim 11, wherein generating the one or more additional response documents based on the set of rules, the predefined device information, the determined one or more discovery devices, the generated one or more discovery documents and the received request by using the document management-based AI model comprises:
determining if the one or more additional response documents are required corresponding to the determined one or more discovery documents in a jurisdiction based on the set of rules, the predefined device information, the determined one or more discovery devices, the generated one or more discovery documents and the received request by using the document management-based AI model;
obtaining additional information associated with the one or more additional response documents from at least one of: the one or more responding users, the responding client via the one or more responding devices and a storage unit upon determining that the one or more additional response documents are required, wherein the additional information comprises at least one of: case number, case name, plaintiffs and defendants, trial and discovery cut-off dates, lead counsel, letterhead, parties, case team, jurisdiction of case, address of clients, contact details of the clients and service list; and
generating the one or more additional response documents based on the set of rules, the predefined device information, the determined one or more discovery devices, the generated one or more discovery documents, the obtained additional information and the received request by using the document management-based AI model.

16. The method of claim 11, further comprising:
determining if the received request is served in conjunction with one or more other requests based on the one or more responses by using the document management-based AI model;
determining a status response corresponding to the one or more non-form devices based on the set of rules, the predefined device information, the determined one or more discovery devices, the generated one or more discovery documents, the one or more responses and the received request by using the document management-based AI model, wherein the status response is one of: admit, deny, unable to admit and deny, and wherein the determined status response is inserted in the one or more responses corresponding to the one or more non-form devices;
receiving one or more bases from one of: the one or more responding users and the responding client for refusal to admit associated with the one or more responses corresponding to the one or more form devices; and
inserting the received one or more bases into the one or more responses corresponding to the one or more form devices.

17. The method of claim 11, wherein determining the one or more responses corresponding to one of: the set of interrogatories and requests associated with the one or more discovery devices based on the set of rules, the predefined device information, the determined one or more discovery devices, the generated one or more discovery documents and the received request by using the document management-based AI model upon performing the one or more operations comprises:
receiving one or more discovery responses for one of: the set of interrogatories and requests in the one or more discovery devices from one of: the one or more responding users and the responding client, wherein the one or more discovery responses comprise at least one of: an addition, a deletion, and a replacement of a written content in the one or more discovery devices
identifying one or more keywords, one or more sentences, and one or more parts of the one or more sentences in the received one or more discovery responses based on one or more predefined ranking rules and the predefined device information by using the document management-based AI model;
ranking each of the identified one or more keywords, the identified one or more sentences, and the identified one or more parts of the one or more sentences based on the one or more predefined ranking rules and the predefined device information by using the document management-based AI model; and
generating the one or more responses corresponding to one of: the set of interrogatories and requests based on the set of rules, the predefined device information, the determined one or more discovery devices, the generated one or more discovery documents, and the received request by using the document management-based AI model upon ranking each of the identified one or more keywords, the identified one or more sentences, and the identified one or more parts of the one or more sentences, wherein the one or more responses are one or more code compliant alternative sentences for updating the one or more discovery responses.

18. The method of claim 11, further comprising:
determining a formatting and a set of content issues for generating a meet and confer document based on the generated one or more propounded documents, response documents, the one or more additional response documents, the set of rules and the predefined device information by using the document management-based AI model;
obtaining one of: the set of interrogatories and requests and the one or more responses corresponding to one of: the set of interrogatories and requests for discovery at issue from a storage unit; and
generating the meet and confer document based on the determined formatting, the determined set of content issues, the obtained set of interrogatories, the obtained one or more responses and the predefined device information by using the document management-based AI model, wherein the meet and confer document comprise case's letterhead, a set of questions, names and addresses of parties.

19. The method of claim 18, further comprising generating a set of responses for the generated meet and confer document based on the set of rules, the predefined device information, the determined one or more discovery devices, the generated one or more discovery documents and the received request by using the document management-based AI model.

20. A non-transitory computer-readable storage medium having instructions stored therein that, when executed by a hardware processor, cause the processor to perform method steps comprising:
receiving a request from one or more propounding users to generate a discovery request via one or more propounding devices, wherein the request comprises at least one of: case number, case name, plaintiffs and defendants, trial and discovery cut-off dates, lead counsel, letterhead, parties, case team, jurisdiction of case, user data, and service list, and wherein the discovery request corresponds to one of: a set of interrogatories and requests in one or more discovery devices;
determining the one or more discovery devices corresponding to the received request based on predefined device information, type of user, and the received request by using a document management-based Artificial Intelligence (AI) model, wherein each of the one or more discovery devices comprises the set of interrogatories;
performing one or more operations corresponding to the determined one or more discovery devices based on the predefined device information and the determined one or more discovery devices by using the document management-based AI model for generating one or more discovery documents, wherein the one or more discovery documents comprise at least one of: one or more form devices, one or more non-form devices, one or more ancillary documents, and Proof of Service (POS), and wherein the one or more discovery devices and the one or more discovery documents are outputted to one or more responding devices associated with one or more responding users;
determining one or more responses corresponding to one of: the set of interrogatories and requests associated with the one or more discovery devices based on a set of rules for a jurisdiction where litigation is taking place, the predefined device information, the determined one or more discovery devices, the generated one or more discovery documents and the received request by using the document management-based AI model upon performing the one or more operations;
generating one or more additional response documents based on the set of rules, the predefined device information, the determined one or more discovery devices, the generated one or more discovery documents and the received request by using the document management-based AI model; and
outputting the determined one or more responses and the generated one or more additional response documents on user interface screen of the one or more responding devices associated with the one or more responding users.
